(19) United States
(12) Patent Application Publication
(10) Pub. No.: US 2026/0291428 A1
(43) Pub. Date: Sep. 24, 2026

(54) ROBOTIC CLEANING OF PHOTOVOLTAIC MODULES

(71) Applicant: Nextpower LLC, Fremont, CA (US)

(72) Inventors: Jitendra Morankar, San Ramon, CA (US); Akshay Keshav Roge, Malad (East) (IN); Alexander W. AU, Oakland, CA (US)

(21) Appl. No.: 19/565,137

(22) Filed: Mar. 12, 2026

Related U.S. Application Data
(60) Provisional application No. 63/775,062, filed on Mar. 20, 2025.

(51) Int. Cl. H02S 40/10; G02B 1/18; H02S 20/32

(52) U.S. Cl. CPC H02S 40/10; G02B 1/18; H02S 20/32

(57) ABSTRACT

A robotic cleaning system includes a robotic body and a coating reservoir. The robotic body includes a controller, a motive source coupled to the controller, a coating applicator coupled to the controller, and an attachment mechanism for attaching the robotic body to a photovoltaic module. The coating reservoir is in fluid communication with the coating applicator to supply a coating material to the coating applicator. The robotic body is configured to apply the coating material, via the coating applicator, to the photovoltaic module.

### RELATED APPLICATIONS

This application claims the benefit of U.S. Provisional Patent Application No. 63/775,062, filed Mar. 20, 2025, the entire contents of which are incorporated herein by reference.

### TECHNICAL FIELD

This disclosure relates generally to robotic cleaning of solar power components, such as photovoltaic modules, sometimes referred to as solar modules. Embodiments disclosed herein describe robotic cleaning of photovoltaic modules, including in some examples robotic application of a coating, in the context of a solar tracker system, though other embodiments can be applied to other solar power component systems.

### BACKGROUND

Photovoltaic (PV) systems are an essential part of renewable energy infrastructure, converting sunlight into electricity to meet growing energy demands sustainably. PV systems, commonly installed as ground-mounted solar farms or rooftop arrays, rely on the unobstructed exposure of solar panels to sunlight for optimal performance. However, environmental factors such as dust, dirt, bird droppings, and other pollutants accumulate on the surface of solar panels over time, significantly reducing their efficiency and energy output.

Traditional methods of cleaning PV panels often involve manual labor or the use of water-based cleaning systems. These methods are labor-intensive, time-consuming, and, in water-scarce regions, unsustainable. Furthermore, the use of detergents or chemicals can lead to environmental contamination, making these methods less desirable for large-scale solar installations.

### SUMMARY

To address these challenges, the present disclosure describes exemplary embodiments of PV robotic cleaning solutions. A PV robotic cleaning solution can be an autonomous or semi-autonomous robotic system specifically designed to clean the surface of solar panels without damaging them. The PV robotic system can include use advanced mechanisms, such as soft brushes, air blowers, or dry cleaning techniques, to remove debris efficiently and sustainably. The PV robotic system can be equipped with smart sensors, machine learning algorithms, and/or remote monitoring capabilities, and thereby can provide a reliable, efficient, and cost-effective solution for maintaining PV system performance.

PV robotic cleaning solutions can be particularly advantageous for utility-scale solar farms and hard-to-reach rooftop installations. By partially or fully automating the cleaning process, these systems reduce operational costs, increase energy yields, and extend the lifespan of solar panels, while minimizing water usage and environmental impact.

In general, the present disclosure describes exemplary embodiments of PV robotic cleaning devices, systems, and methods that can perform a PV module cleaning function. Some such exemplary embodiments include PV robotic cleaning devices, systems, and methods that can perform a PV module cleaning function by at least applying a coating to the PV module. For example, certain such embodiments disclosed herein include PV robotic cleaning devices, systems, and methods that perform a PV module cleaning function by sweeping a PV module and applying a coating to the PV module (e.g., applying the coating to the PV module after the PV module has been swept). The coating applied to the PV module by the robotic cleaning system can be configured to reduce particulate accumulation at the PV module where the coating is applied (e.g., the coating can be a hydrophobic coating that acts to reduce dust/dirt particulate accumulation at the PV module). As such, once the PV module has had such a cleaning function performed on it via the robotic cleaning system, future cleaning of that PV module may be reduced.

One embodiment includes a robotic cleaning system. This robotic cleaning system embodiment includes a robotic body and a coating reservoir. The robotic body includes a controller, a motive source coupled to the controller, one or more wheels coupled to the motive source, a coating applicator coupled to the controller, and an attachment mechanism for attaching the robotic body to a photovoltaic module. The coating reservoir is in fluid communication with the coating applicator to supply a coating material to the coating applicator. The robotic body is configured to apply the coating material, via the coating applicator, to the photovoltaic module.

In a further embodiment of this robotic cleaning system, the coating material comprises a hydrophobic coating that is configured to reduce particulate accumulation at the photovoltaic module.

In a further embodiment of this robotic cleaning system, the robotic body further includes a brush assembly coupled to the controller. The robotic body can be configured to apply the coating material, via the coating applicator, to the photovoltaic module as the robotic body moves along the photovoltaic module via the one or more wheels. The brush assembly can be disposed at the robotic body ahead of the coating applicator relative to a direction of travel of the robotic body. The coating applicator can be configured, at the robotic body, to apply the coating material to the photovoltaic module after the brush assembly has passed the photovoltaic module. For example, the brush assembly can be a first brush assembly, and the robotic body can further include a second brush assembly, where the second brush assembly is disposed, at the robotic body, behind the coating applicator relative to the direction of travel of the robotic body. For instance, the second brush assembly can be configured to perform a finishing operation (e.g., buffing, polishing, etc.) to the coating material applied at the photovoltaic module.

In a further embodiment of this robotic cleaning system, the coating applicator includes a plurality of nozzles spaced apart from one another about the robotic body. For example, the attachment mechanism can include a first attachment mechanism at a first side of the robotic body configured to attach directly to a first end portion of the photovoltaic module and a second attachment mechanism at a second, opposite side of the robotic body configured to attach directly to a second, opposite end portion of the photovoltaic module. The plurality of nozzles can be disposed at the robotic body between the first attachment mechanism and the second attachment mechanism.

In a further embodiment of this robotic cleaning system, the robotic body further includes: a valve coupled to the controller and in fluid communication with the coating applicator and the coating reservoir; and a flow meter in fluid communication with the coating applicator and the coating reservoir. The valve is controllable by the controller to alter a fluid pressure and a fluid velocity of the coating material output from the coating applicator.

In a further embodiment of this system, the robotic body further includes a cleaning solution applicator coupled to the controller. For example, the coating applicator can include a first plurality of nozzles spaced apart from one another along a first location at the robotic body, and the cleaning solution applicator can include a second plurality of nozzles spaced apart from one another along a second, different location at the robotic body. The first plurality of nozzles can be configured, at the robotic body, to apply the coating material to the photovoltaic module after the brush assembly has passed the photovoltaic module and after the second plurality of nozzles has passed over the photovoltaic module. In some such examples, the robotic cleaning system can further includes a cleaning solution reservoir in fluid communication with the second plurality of nozzles to supply at least a fluid cleaning solution to the second plurality of nozzles.

Another embodiment includes a method of applying a coating to a photovoltaic module. This method embodiment includes the steps of: moving a robotic body relative to a photovoltaic module to perform a cleaning operation at the photovoltaic module using a cleaning solution applicator at the robotic body; and during or after performing the cleaning operation at the photovoltaic module, applying a coating material to the photovoltaic module using a coating applicator at the robotic body.

In a further embodiment of this method, the coating material can be applied to at least a region of the photovoltaic module using the coating applicator at the robotic body after the cleaning solution applicator has passed over the region of the photovoltaic module. In some examples, the cleaning applicator can include a brush. In some examples, the brush can be a first brush that is disposed ahead of, relative to a direction of travel of the robotic body, the coating applicator. The robotic body can further include a second brush that is disposed behind, relative to the direction of travel of the robotic body, the first brush and the coating applicator. And the method can include, after applying the coating material to photovoltaic module, using the second brush to finish (e.g., buff, polish, etc.) the coating material at the photovoltaic module.

In a further embodiment of this method, the method can additionally include attaching the robotic body to the photovoltaic module such that the one or more wheels at the robotic body contact the photovoltaic module.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings.

FIG. 1 is a perspective view of an embodiment of a solar tracker system.

FIG. 2 is a schematic, top view of a solar tracking system arranged in rows of continuous trackers spaced apart from one another, with a PV robotic cleaning system performing a PV module cleaning function at PV modules of a row.

FIG. 3 is a block diagram of an embodiment of a PV robotic cleaning system.

FIG. 4 is a perspective view of an embodiment of a PV robotic cleaning system.

FIGS. 5A-5C illustrate an embodiment of a robotic body that can be part of a PV robotic cleaning system. FIG. 5A is a perspective view of the robotic body at a PV module, FIG. 5B is an elevational view of the robotic body at the PV module, and FIG. 5C is a close-up perspective view of an exemplary coating applicator and brush assembly at the robotic body.

FIGS. 6A and 6B illustrate another embodiment of a robotic body that can be part of a PV robotic cleaning system. FIG. 6A is a perspective view of the robotic body at a PV module, and FIG. 6B is an elevational view of the robotic body at the PV module.

FIG. 7 is a flow diagram of an embodiment of a method of applying a coating to a photovoltaic module using a robotic body.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to PV robotic cleaning. Such embodiments can be configured to execute a cleaning operation at one of more PV modules, such as by applying a maintenance solution to such one or more PV modules. Various maintenance solutions can be applied within the scope of the present disclosure, including applying maintenance solutions such as one or more coating materials and/or one or more fluid cleaning solutions (e.g., pressurized air and/or one or more liquid cleaning solutions, such as atomized liquid cleaning solution).

For instance, some such exemplary embodiments include PV robotic cleaning devices, systems, and methods that can perform a PV module cleaning function by at least applying a coating to the PV module (sometimes referred to as a solar module). For example, certain such embodiments disclosed herein include PV robotic cleaning devices, systems, and methods that perform a PV module cleaning function by cleaning (e.g., sweeping, blowing, wiping, etc.) a PV module and applying a coating to the PV module (e.g., applying the coating to the PV module after the PV module has been cleaned). The coating applied to the PV module by the robotic cleaning system can be configured to reduce particulate accumulation at the PV module where the coating is applied (e.g., the coating can be a hydrophobic coating that acts to reduce dust/dirt particulate accumulation at the PV module). As such, once the PV module has had such a coating applied on it via the robotic cleaning system, future resources associated with cleaning of that PV module may be reduced.

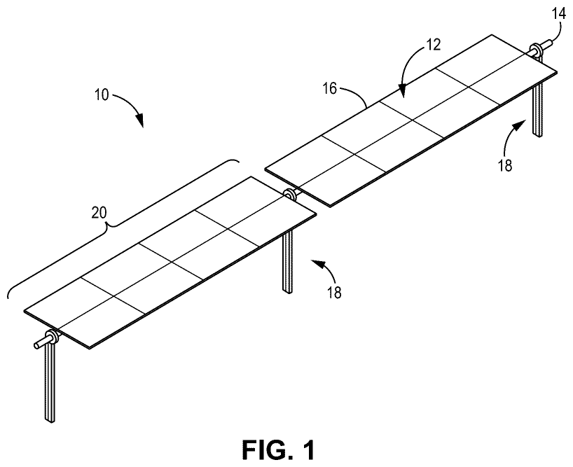

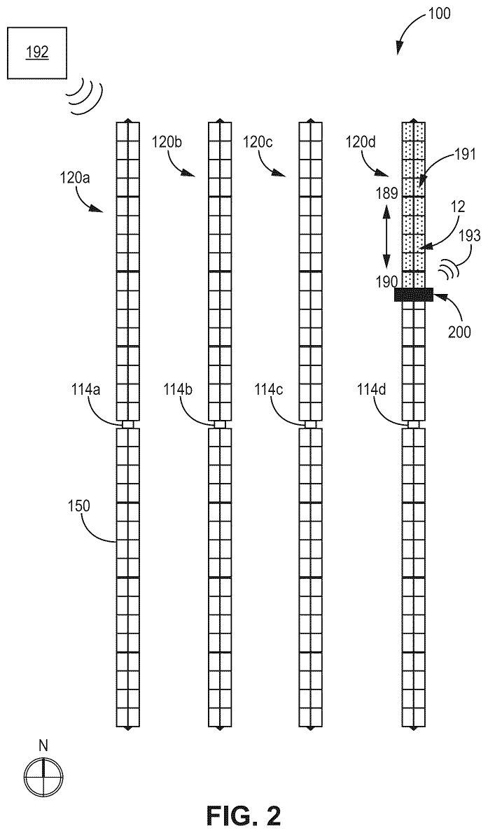

FIG. 1 is an elevation view of a common arrangement of a solar tracker 10 provided in accordance with the present disclosure. In some applications, a plurality of solar trackers 10 may be arranged in a north-south longitudinal orientation to form rows of a solar array, such as illustrated at FIG. 2. The solar tracker 10 may be formed of a plurality of bays 20 defined by the distance between ground pile support structures 18 (generally referenced herein as piles 18). The ground piles 18 may be disposed in spaced relation to one another and partially embedded in the earth. In some examples, the ground piles 18 may be multi-component tubular support members, or A-frame supports, and/or may be configured to couple to A-frame supports. The piles 18 may have one or more embedment in the ground, such as one for each leg of an A-frame support where the embedments are spaced apart in the east-west direction. FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16. Each of the bearings 22 and the drive mechanism 16 are supported by one of the piles 18. Activation of the drive mechanism rotates a torque tube 14 about an axis of rotation and thus rotates one or more PV modules (or “solar modules”) 12 mounted to the torque tube 14 such that the PV modules 12 can be oriented to a desired position. That desired position may be to a position to maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the PV modules 12.

The torque tube 14 is sized (e.g., diameter, wall thickness, material) such that sag between the piles 18 is reduced or substantially eliminated and to absorb torsional loads applied to the torque tube 14 by wind loading. In addition, since there is often just a single drive mechanism 16, the specifications for the torque tube 14 may desire to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−75 degrees or more), for example, during stowing.

As will be appreciated, the PV modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the PV modules 12 relative to the sun, while supporting the PV modules 12 on the bracket system. The bracket system may take many forms including two pieces of shaped steel, which may be arranged to sandwich the PV modules 12, and may be configured to connect to a rail, which is then coupled to the torque tube 14.

Each PV module 12 of the solar tracker 10 can include one or more PV cells that is configured to convert sunlight into electrical energy. Each PV module can have a plurality of PV cells disposed along on a laminate substrate, and the laminate substrate can be at least partially bounded by a frame. Thus, as sunlight irradiates onto the PV cells, the PV module can generate electrical energy. However, when particulate has accumulated onto the PV module, it can obstruct this electrical generation function of the PV module. Accordingly, the function of applying a coating that can reduce particulate accumulation at the PV module (e.g., reduce particulate accumulation over the PV cells) can be useful in reducing or preventing future degradation of the electrical generation function of the PV module.

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. Each one of the plurality of solar module assemblies 150 may be supported on a torque tube 114a, 114b, 114c, 114d (generally referred to herein as torque tube 114), which in turn is supported by a plurality of support piers (not explicitly shown in FIG. 2). The torque tube 114 may be an example of the torque tube 14, as in FIG. 1. As shown, the solar tracker rows 120 may be separated by a space sufficient to allow machinery to travel therethrough to allow for cleaning and maintenance.

As noted, PV robotic cleaning system and method embodiments described herein can perform a PV module cleaning function by at least applying a coating 191 to a PV module 12. FIG. 2 shows a schematic illustration of a PV robotic cleaning system 200 performing a PV module cleaning function by at least applying the coating 191 to one or more PV modules 12. As shown here, the PV robotic cleaning system 200 can move relative to PV modules 12, for instance relative to a given row 120d, so as to traverse PV modules 12 of the given row 120d, such as in a direction 190. The direction 190 can be a north or south direction such that the PV robotic cleaning system 200 moves along the given row 120d in the north or south direction. For certain embodiments, the PV robotic cleaning system 200 can be configured to move bi-directionally along the given row 120d such that the PV robotic cleaning system 200 can be configured to move in both a north and a south direction along the given row 120d, though other applications can include robotic system 200 movement in additional or alternative direction(s). As the PV robotic cleaning system 200 is moved relative to a given PV module 12, the PV robotic cleaning system 200 can deposit coating 191 onto the PV module 12. For instance, at shown at FIG. 2, when the PV robotic cleaning system 200 is moved along one or more PV modules 12 in the direction 190, the PV robotic cleaning system 200 can apply the coating 191 along the row 120d in the direction 190. The coating 191, when deposited at the PV module 12 via the PV robotic cleaning system 200, can be configured to both: (i) reduce particulate accumulation at the PV module 12, and (ii) transmit sunlight therethrough. For instance, the coating 191 can be include a hydrophobic coating material that is configured to repel particulate, such as to repel dirt/dust, from the PV module 12 where the coating 191 is deposited while allowing for sunlight to pass through the coating 191 to the PV cells over which the coating 191 has been applied.

As shown in FIG. 2, the PV robotic cleaning system 200 can be configured for communication with a remote server 192. In the illustrated example, the PV robotic cleaning system 200 is in wireless communication 193 with the remote server 192. For example, the PV robotic cleaning system 200 can include one or more remotely monitored components in data communication with the remote server 192. Accordingly, as the PV robotic cleaning system 200 is operated at one or more PV modules 12, data from the PV robotic cleaning system 200 can be communicated to the remote server 192. This can, for example, facilitate remote monitoring (e.g., real-time) and/or control of the PV robotic cleaning system 200 via the remote server 192. In addition, in some cases, the PV robotic cleaning system 200 can be in bi-directional communication with the remote server 192 such that the remote server 192 can transmit instructions or other data to the PV robotic cleaning system 200, for instance, to actuate a control function at the PV robotic cleaning system 200. In some embodiments, the PV robotic cleaning system 200 can integrate with Supervisory Control and Data Acquisition (SCADA) system(s) to enable remote monitoring and control of the PV robotic cleaning system 200. For example, the PV robotic cleaning system 200 can be remotely monitored and controlled as to coating application and/or cleaning fluid (e.g., water and/or a cleaning solution and/or pressurized air) application metrics.

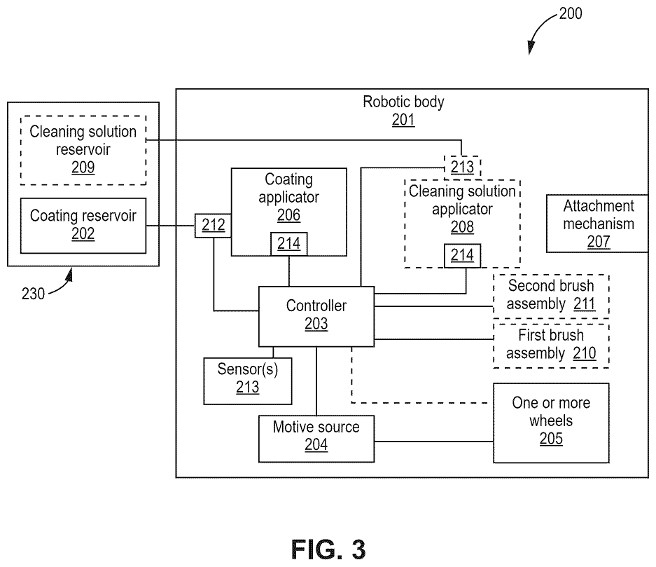

FIG. 3 is a block diagram of an embodiment of PV robotic cleaning system 200. The illustrated embodiment of the PV robotic cleaning system 200 includes a robotic body 201 and one or more maintenance solution reservoirs, such as coating reservoir 202 and/or cleaning solution reservoir 209. The robotic cleaning system 200 can be used to perform one or more operations at a solar tracker, as discussed herein. Though other embodiments within the scope of this disclosure can include applications of the robotic cleaning system 200 at static solar power generation structures as well.

The robotic body 201 can include at least a controller 203, a motive source 204 coupled to the controller 203, one or more wheels 205 coupled to the motive source 204, and a maintenance solution applicator coupled to the controller 203. The illustrated embodiment includes a coating applicator 206 as one type of maintenance solution applicator, and the coating applicator 206 is coupled to the controller 203. The controller 203 can be configured to cause the motive source to apply a motive force to the one or more wheels 205 to cause the robotic body 201 to move relative to one or more PV modules 12. And, the controller 203 can be configured to actuate the maintenance solution applicator (e.g. the coating applicator 206) to cause one or more maintenance solutions (e.g., a coating material and/or a fluid cleaning solution) to be output onto the one or more PV modules 12. For example, the controller 203 can be configured to move the robotic body 201 along one or more PV modules 12 (e.g., along row 120d) and to output one or more maintenance solutions from the maintenance solution applicator at an output rate corresponding to the speed at which the controller moves the robotic body 201 along one or more PV modules 12. This can be helpful in outputting a desired about of maintenance solution at a given area of one or more PV modules 12.

The illustrated embodiment of the robotic body 201 at FIG. 3 also includes an attachment mechanism 207. The attachment mechanism 207 can be configured to attach the robotic body 201, directly or indirectly, to one or more solar tracker components, such as to one or more PV modules 12, such as one or more PV modules 12 along the row 120d. The attachment mechanism 207 can attach the robotic body 201, directly or indirectly, to one or more PV modules 12 such that the robotic body 201 can move along the one or more PV modules 12 (e.g., move along the row 120d via relative movement between the attachment mechanism 207 and the PV modules 12 of the row 120d).

In addition, some embodiments of the robotic body 201, such as that illustrated at FIG. 3, can include one or more sensors 213 coupled to controller 203. The one or more sensors 213 can be configured to detect one or more measurable operating characteristics related to the robotic body 201 and/or a maintenance operation being performed by the robotic body 201. For example, the robotic body 201 can include a wind speed sensor that is configured to detect wind speed ambient to the robotic body 201, and the controller 203 can be configured to adjust a maintenance operation being performed by the robotic body 201 when the detected wind speed exceeds a predetermined threshold. As one exemplary such application, the controller 203 can be configured to adjust an output flow rate of a coating material from the coating applicator 206 when detected wind speed ambient to the vehicle body 201 exceeds a predetermined wind speed threshold. This can help to optimize adherence of the coating material and/or reduce waste associated with output coating material that may migrate off target as a result of the ambient wind force. To do so, the robotic body 201 can include an anemometer to detect wind speed (e.g., and wind direction) ambient to the robotic body 201. Other additional or alternative examples can include the robotic body 201 having one or more flowmeters (e.g., associated with the coating applicator 206 and/or cleaning solution applicator 208), temperature sensors (e.g., associated with the coating reservoir 202 and/or the cleaning solution reservoir 209), pressure sensors (e.g., associated with the coating reservoir 202 and/or the cleaning solution reservoir 209). For instance, as one exemplary application, when the temperature associated with the coating reservoir 202 and/or the cleaning solution reservoir 209 is below a predetermined temperature threshold, the controller 203 can be configured to adjust (e.g., reduce, such as terminate) an output of the coating material and/or the cleaning solution from the respective reservoir 202, 209.

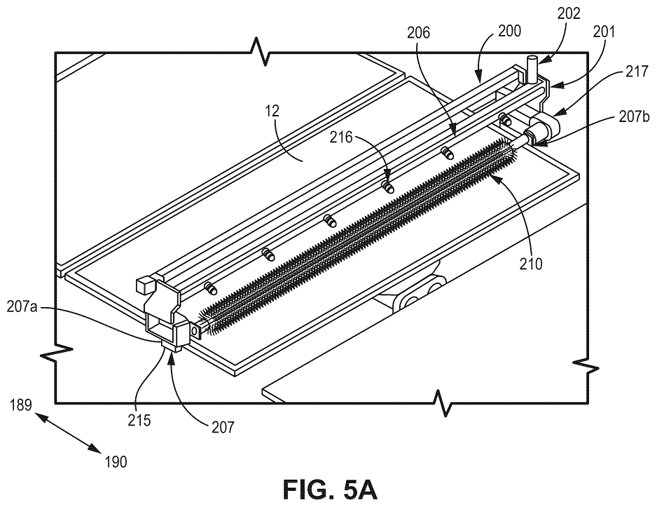

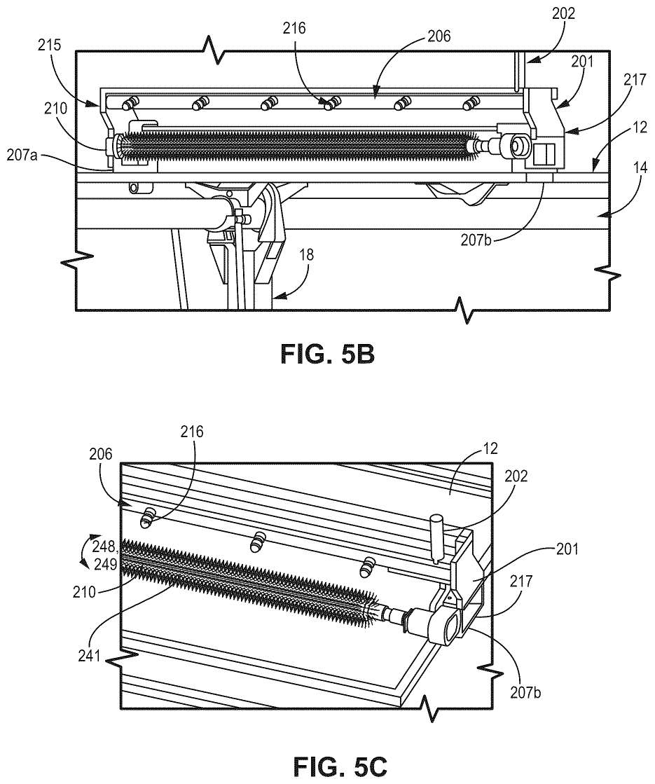

As noted, in addition to the robotic body 201, the system 200 can also include one or more reservoirs, such as coating reservoir 202 and/or cleaning solution reservoir 209. The one or more reservoirs 202, 209 can be configured to supply one or more maintenance solutions, such as one or more coating materials and/or one or more cleaning solutions, respectively, to the maintenance solution application (e.g., the coating applicator 206 and/or the cleaning solution applicator 208, respectively). In some examples, the one or more reservoirs 202, 209 can be carried at the robotic body 201, such as shown at the example at FIGS. 5A-5C. But in other examples, the one or more reservoirs 202, 209 can be in fluid communication with the maintenance solution applicator (e.g., the coating applicator 206 and/or the cleaning solution applicator 208, respectively) but offboard, and thus remote from, the robotic body 201, such as shown at the examples at FIG. 3 and. 4. In such examples where the one or more reservoirs 202, 209 are offboard the robotic body 201, the one or more reservoirs 202, 209 can be carried at a mobile cart 230 that is movable (e.g., with the robotic body 201), with the one or more reservoirs 202, 209 in fluid communication between the mobile cart and the maintenance solution applicator. Thus, the offboard reservoir 202 and/or 209 can be disposed on mobile cart 230 accompanying the robotic body 201.

Whether onboard or offboard the robotic body 201, the coating reservoir 202 can be in fluid communication with the maintenance solution applicator at the robotic body 201. The coating reservoir 202 can be in fluid communication with the coating applicator 206 to thereby supply one or more coating materials to the coating applicator 206.

For example, the controller 203 can cause one or more coating materials to be conveyed from the reservoir 202 to the coating applicator 206 such that the robotic body 201 is configured to apply the one or more coating materials, via the coating applicator 206, to one or more photovoltaic modules or other solar tracker component(s). As one examples, the coating material can include a hydrophobic and/or anti-static coating that is configured to reduce particulate accumulation at PV modules. Thus, the robotic body 201, via the controller 203 and coating applicator 206, can be configured to deposit a hydrophobic coating onto one or more PV modules. For instance, the robotic body 201, via the controller 203 and coating applicator 206, can be configured to deposit a hydrophobic coating over photovoltaic cells at one or more PV modules such that the photovoltaic cells are overlaid by a hydrophobic coating layer. The robotic body 201 can do so as the robotic body 201 moves along the PV modules, for instance, via the robotic body 201 traversing along a given row of a solar tracker to deposit such a coating at the PV modules along that given row. As a result of the applied coating, the PV modules of the row may be imparted with an enhanced ability to repel ambient airborne particulate from the surface of the PV modules to thereby reduce or prevent energy generation obstruction.

Depending on the application and desired maintenance tasks to be performed, the robotic body 201 can additionally include one or more brush assemblies 210, 211 coupled to, and controllable by, the controller 203. Each of the one or more brush assemblies can include a brush member 241 that can be rotatably driven, about a rotational axis, in direction(s) 248, 249, and relative to the robotic body 201 to sweep, buff, polish, or perform other brush-related maintenance task at PV module 12. The one or more brush assemblies 210, 211 can be configured to perform one or more maintenance operations at one or more PV modules, for instance, in coordination with the maintenance solution applicator (e.g., in coordination with the coating applicator 206 and/or the cleaning solution applicator 208). For example, the one or more brush assemblies 210, 211 can be configured to contact a given PV module and to perform at least one maintenance task at the contacted surface of the PV module. Such maintenance tasks performed by the one or more brush assemblies 210, 211 can vary depending on the application of the maintenance solution applicator.

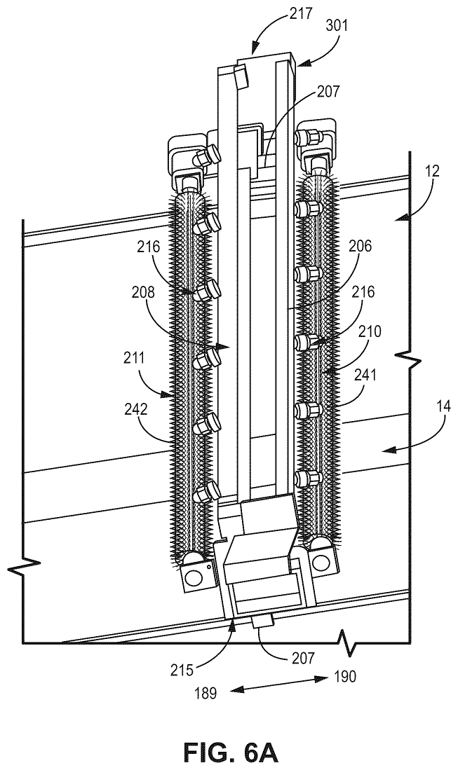

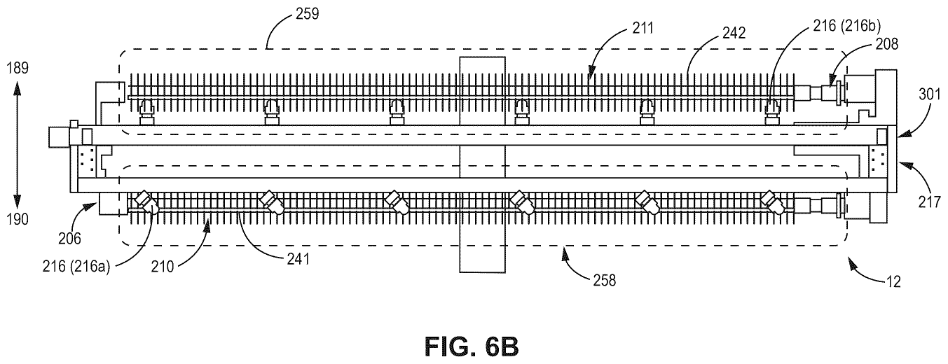

For example, when the robotic body 201 is configured to apply one or more coating materials, via the coating applicator 206, to the photovoltaic module as the robotic body moves along the photovoltaic module, the one or more brush assemblies 210, 211 can perform a cleaning function and/or a coating finishing function. For example, when the robotic body 201 moves in a direction along a tracker row such that at least one brush assembly 210, 211 is disposed at the robotic body 201 to lead the coating applicator 206, the at least one brush assembly 210, 211 leading the coating applicator 206 can first perform a sweeping function to remove particulate at a given surface area of a given PV module followed by the coating applicator 206 then depositing one or more coating materials at the same given area of the given PV module after it has been swept. This order of maintenance operations can be useful in improving the adherence of the coating material at the swept PV module surface. As another example, when the robotic body 201 moves in a direction along a tracker row such that the coating applicator 206 is disposed at the robotic body 201 to lead the at least one brush assembly 210, 211, the at least one brush assembly 210, 211 trailing the coating applicator can perform a coating finishing function at the deposited coating material after the coating applicator has deposited the coating material at a given surface area of a PV module. As a yet further example, where the robotic body 201 include both first brush assembly 210 and second brush assembly 211, first brush assembly 210 can be disposed to lead the coating applicator 206 and thus first brush assembly 210 can perform the leading sweeping function ahead of the coating applicator 206 while the second brush assembly 211 can be disposed to trail the coating applicator 206 and thus the second brush assembly 211 can perform the trailing coating finishing function behind the coating applicator 206. These and other examples are further described in refence to FIG. 6B.

As noted, in some embodiments, the maintenance solution applicator can include the cleaning solution applicator 208 in addition to the coating applicator 206. Thus, in such embodiments, the robotic body 201 can perform maintenance tasks at PV modules including coating applications and fluid cleaning solution applications. Fluid cleaning solution applications can include output of one or more fluid cleaning solutions (e.g., pressurized air and/or liquid detergent solution, such as atomized liquid detergent solution) at a PV module or other solar tracker component. The illustrated embodiment of the PV robotic cleaning system 200 shows cleaning solution applicator 208 carried at robotic body 201 along with the coating applicator 206. The illustrated embodiment of the PV robotic cleaning system 200 shows the cleaning solution reservoir 209 as offboard the robotic body 201 and in fluid communication with the cleaning solution applicator 208. For instance, the offboard cleaning solution reservoir 209 can be disposed at mobile cart 230 (e.g., the same mobile cart 230 as the coating reservoir 202) that accompanies the robotic body 201 and can be in fluid communication with the cleaning solution applicator 208 at the robotic body 201. Though other embodiments within the scope of the present disclosure can have some, or all, of the cleaning solution reservoir 209 can be carried onboard at the robotic body 201. For instance, the coating solution reservoir 202 and/or the cleaning solution reservoir 209 could be one or more replaceable bottles carried at the robotic body 201, such as shown at FIGS. 5A-5C. Thus, the robotic body 201 can carry the coating reservoir 202 and/or the cleaning solution reservoir 209 onboard and/or offboard the robotic body 201.

As also shown at the embodiment of FIG. 3, the robotic body 201 can further include one or more valves 212, 213 in fluid communication between the maintenance solution applicator and the one or more reservoirs 202, 209. For instance, a first valve 212 can be in fluid communication between the coating reservoir 202 and the coating applicator 206, and a second valve 213 can be in fluid communication between the cleaning solution reservoir 209 and the cleaning solution applicator 208. The one or more valves 212, 213 can be coupled to, and controllable by, the controller 203. For example, each of the one or more valves 212, 213 can be controllable by the controller 203 to alter a fluid pressure and a fluid velocity of the coating material output from the coating applicator 206. This could include the controller 203 altering a fluid pressure and a fluid velocity of the coating material output from the coating applicator 206 as a function of one or more measurable operating characteristics detected by one or more sensor(s) 213 at robotic body 201. For example, the controller 203 can be configured to alter the fluid pressure and a fluid velocity of the coating material output from the coating applicator 206 as a function of the speed at which the controller 203 moves the robotic body 201 along one or more PV modules (e.g., along row 120d). Some embodiments can additionally include at the robotic body 201 one or more flow meters 214 coupled to the controller 203 and in fluid communication with the coating applicator 206 and/or the cleaning solution applicator 208.

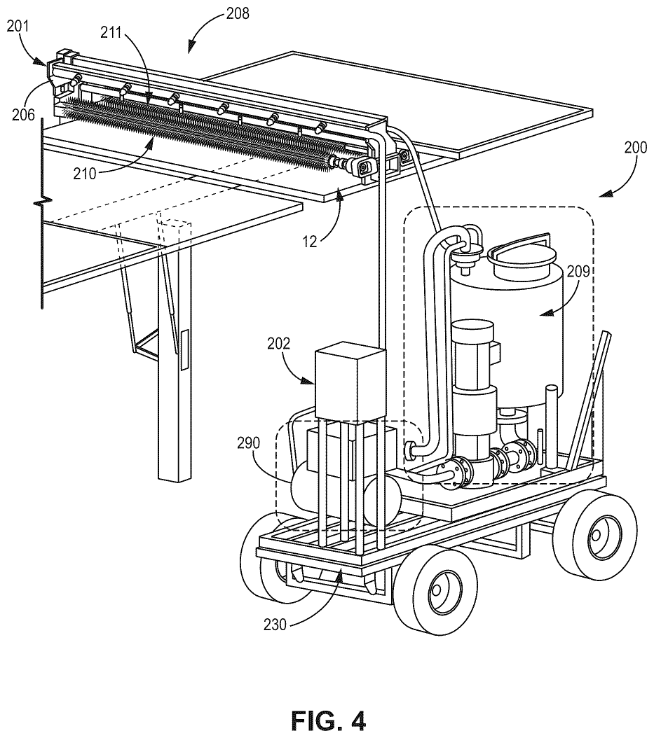

FIG. 4 illustrates a perspective view of an embodiment of PV robotic cleaning system 200. The PV robotic cleaning system 200 shown here at FIG. 4 can include components described in reference to the block diagram at FIG. 3. PV robotic cleaning system 200 at FIG. 4 illustrates an example where both the coating reservoir 202 and the cleaning solution reservoir 209 are carried at mobile cart 230. Here, the reservoirs 202, 209 are offboard the robotic body 201, and robotic body 201 is fluidly connected to the reservoirs via fluid connection lines. The embodiment of the system at FIG. 4 also includes an air compressor 290 that be in fluid communication with one or both reservoirs 202, 209 and/or one or both applicators 206, 208 to increase fluid pressure in the system 200. In some examples, the system 200 can additionally include one or more atomizers or venturi mechanisms also in fluid communication with one or both reservoirs 202, 209 and/or one or both applicators 206, 208 to provide atomized liquid output (e.g., atomized coating material; atomized liquid cleaning solution, such as water and/or detergent) onto PV module 12.

The embodiment of the PV robotic cleaning system 200 shown at FIG. 4 can, for instance, be configured as an autonomous or semi-autonomous system 200 that is configured to autonomously, or semi-autonomously, perform one or more maintenance tasks at PV modules. For example, the system 200 at FIG. 4 can be configured to execute self-driven movement of the robotic body 201 along PV modules at a tacker row while autonomously executing one or more maintenance tasks at such PV modules, such as by applying a coating material and/or applying a fluid cleaning solution. The schematic diagram of the system 200 at FIG. 3 can thus form a closed-loop feedback and control system operable to autonomously execute one or more maintenance tasks while the robotic body 201 moves relative to the PV modules.

FIGS. 5A-5C illustrate an exemplary embodiment of robotic body 201 that can be part of the PV robotic cleaning system, such as the PV robotic cleaning system 200 of FIG. 3. FIG. 5A is a perspective view of the robotic body 201 at PV module 12, FIG. 5B is an elevational view of the robotic body 201 at the PV module 12, and FIG. 5C is a close-up perspective view of an exemplary coating applicator 206 and brush assembly 210 at the robotic body 201.

The example of the robotic body 201 illustrated at FIGS. 5A-5C includes coating solution applicator 206 disposed as spaced apart from and offset from the brush assembly 210 along a longitudinal axis of the robotic body 201. As such, depending on the direction of travel 190, 189, the robotic body 201, the robotic body 201 here can be configured to apply brush assembly 210 at one or more PV modules 12 at least at one different time than the robotic body 201 applies one or more maintenance solutions (e.g., applies a coating material).

In an example where the robotic body is to apply a coating, if the robotic body 201 travels in direction 190, the brush assembly 210 will lead the coating applicator 206 such that the brush assembly 210 can first be applied to a given surface area of PV module 12 and then the coating applicator 206 can follow and apply a coating material to that given surface area of the PV module 12 after the brush assembly 210. This can help to precondition, via the brush assembly 210, the PV module 12 to then receive the coating material from the coating applicator 206 such that the adherence rate of the coating material on the surface of the PV module can be increased. This could include the brush assembly 210 sweeping away particulate (dust, dirt, etc.) from the surface of the PV module. For instance, the brush assembly 210 can be operable to first sweep a given surface area of the PV module 12 and then that swept surface area of the PV module 12 can have the coating material deposited thereat via the coating applicator. Thus, the brush assembly 210 can be disposed at the robotic body 201 ahead of the coating applicator 206 relative to direction 190 of travel of the robotic body 201 relative to PV module 12, and, when the robotic body travels in the direction 190, the coating applicator 206 can be configured at the robotic body 201 to apply the coating material to the PV module 12 after the brush assembly 210 has passed the PV module 12. Similarly, as noted, the maintenance fluid applicator in some embodiments can include cleaning solution applicator 208 at the robotic body 201, and, thus, the brush assembly 210 can be disposed at the robotic body 201 ahead of the cleaning solution applicator 208 relative to direction 190 of travel of robotic body 201. Thus, the robotic body 201 can additionally or alternative apply a fluid cleaning solution (e.g., pressurized air and/or liquid detergent, such as atomized liquid detergent) when traveling in the direction 190.

Robotic body 201 can also be configured to traverse PV modules 12 in direction 189, in which case a maintenance operation can be performed at the PV modules 12 with the maintenance solution applicator (e.g., coating applicator 206 and/or cleaning solution applicator 208) leading the brush assembly 210. For example, when the robotic body 201 travels in the direction 189, the coating applicator 206 can first output a coating material to a given surface area of PV module 12 and then brush assembly 210 can act to finish the coating material at the given surface area of the PV module. For example, after the coating applicator 206 has applied the coating material(s), the brush assembly can be controlled to then buff, polish, or otherwise finish the coating material at the surface of the PV module 12 to form a coating layer over the PV module 12 after the brush assembly 210 has passed. Similarly, as noted, the maintenance fluid applicator in some embodiments can include cleaning solution applicator 208 at the robotic body 201, and, thus, the brush assembly 210 can be disposed at the robotic body 201 behind the cleaning solution applicator 208 relative to direction 189 of travel of robotic body 201. Thus, the robotic body 201 can additionally or alternative apply a fluid cleaning solution (e.g., pressurized air and/or liquid detergent, such as atomized liquid detergent) when traveling in the direction 189.

The embodiment illustrated at FIGS. 5A-5C illustrates the coating applicator 206 as including a plurality of nozzles 216. As shown for this example, the plurality of nozzles 216 can be spaced apart from one another about the robotic body 201. For instance, the plurality of nozzles 216 can be spaced apart and aligned along an axis that extends transverse to the longitudinal axis of the robotic body 201 (e.g., and transverse to the direction of travel 189, 190 of the robotic body 201). The plurality of nozzles 216 can have an outlet cross-sectional geometry that is different when the plurality of nozzles 216 are included at the coating applicator 206 versus when included at the cleaning solution applicator 208. For instance, the outlet cross-sectional area of the plurality of nozzles 216 can be smaller when included at the coating applicator than when included at the cleaning solution applicator 208.

FIGS. 5A-5C further illustrate an example of the attachment mechanism 207. The attachment mechanism 207 can be configured to movably couple the robotic body 201 to one or more solar tracker components. The example here shows the attachment mechanism 207 movably coupling the robotic body 201 to a frame portion of PV module 12 such that the robotic body 201 can move along frame portions of PV modules 12 to execute one or more maintenance operations at the PV modules 12 as the robotic body 201 moves there along. The attachment mechanism 207 can include a first attachment mechanism 207a at a first side 215 of the robotic body 201 configured to attach directly to a first end portion of the PV module 12 and a second attachment mechanism 207b at a second, opposite side 217 of the robotic body 201 configured to attach directly to a second, opposite end portion of the PV module 12. As illustrated here, the plurality of nozzles 216 (e.g., of the coating applicator 206 and/or of the cleaning solution applicator 208) can be disposed at the robotic body 201 between the first attachment mechanism 207a and the second attachment mechanism 207b.

FIGS. 6A and 6B illustrate another embodiment of robotic body 301 that can be part of the PV robotic cleaning system 200. FIG. 6A is a perspective view of the robotic body 301 at PV module 12, and FIG. 6B is an elevational view of the robotic body 301 at the PV module 12.

The robotic body 301 can include the first brush assembly 210 and the second brush assembly 211. The first and second brush assemblies 210, 211 can be disposed at the robotic body 301 spaced apart from one another such that respective brush members 241, 242 at the first and second brush assemblies 210, 211 can act simultaneously at different surface areas 258, 259 at one or more PV modules 12. The first brush assembly 210 can be operable in association with the coating applicator 206, while the second brush assembly 211 can be operable in association the cleaning solution applicator 208. Thus, the robotic body 301, via the controller, can be configured to perform one maintenance operation at the first PV module surface area 258 using the first brush assembly 210 and the coating applicator 206 (e.g., at least partially sequential use of the first brush assembly 210 and the coating applicator 206 at the first PV module surface area 258), and, at the same or different time, the robotic body 301, via the controller, can be configured to perform another, different maintenance operation at the second PV module surface area 259 using the second brush assembly 211 and the cleaning solution applicator 208 (e.g., at least partially sequential use of the second brush assembly 211 and the cleaning solution applicator 208 at second PV module surface area 259).

For instance, the robotic body 301 can be configured to perform two or more different maintenance operations at one or more PV modules 12. This can include the robotic body 301 configured to perform sequentially one or a coating application and a fluid cleaning solution application to one or more PV modules 12 followed then in time by the other of the coating application and the fluid cleaning solution application. In some such examples, the robotic body 301 can have the first brush assembly 210 disposed at the robotic body 301 at least partially offset (e.g., behind) the coating applicator 206 relative to the direction of travel 189 and can have the second brush assembly 211 disposed at the robotic body 301 at least partially offset (e.g., ahead of) the cleaning solution applicator 208. With such a configuration, the first brush assembly 210 can be configured to perform a finishing operation to the deposited coating material applied at the photovoltaic module 12 after the second brush assembly 211 has performed a particulate removal operation (e.g., using brush member 242 and/or output fluid cleaning solution) when moving in the direction 189.

For example, when the robotic body 301 travels in the direction 189, the fluid cleaning solution application can be applied to the surface area 259 at one or more PV modules 12 first followed then by execution, via the robotic body 301, of the coating application at the surface area 259 at one or more PV modules 12. In one such example, this could include the robotic body 301 first applying pressurized air, liquid detergent, or both, with or without rotatably driving brush member 242, at the surface area 259, followed then by the robotic body 301 next applying the brush member 241 and/or a coating material at that recently cleaned surface area 259. For instance, the surface area 259 can first be at least swept by the brush member 242 and then the first surface area can have the coating material deposited thereat, followed next by the brush member 241 acting to finish (e.g., buff, polish, etc.) the deposited coating material to form a coating layer at the surface area 259. On the other hand, when the robotic body 301 travels in the direction 190, when the robotic body 301 travels n the direction 190, the coating application can first be applied at the surface area 258 at one or more PV modules 12 followed then by execution, via the robotic body 301, of the fluid cleaning solution application at the surface area 258.

When traveling in the direction 189, first plurality of nozzles 216a at robotic body 301 can be configured to apply the coating material to the PV module 12 after the brush assembly 210 and/or 211 has passed the PV module 12 and after the second plurality of nozzles 216b has passed over the PV module. The second plurality of nozzles 216b, in some applications, can be configured to receive one or more fluid cleaning solutions from one or more fluid cleaning solution reservoirs and to output this received one or more fluid cleaning solutions from the second plurality of nozzles 216b. The opposite can be true when traveling in the direction 190. further comprising: a cleaning solution reservoir in fluid communication with the second plurality of nozzles to supply at least a fluid cleaning solution to the second plurality of nozzles

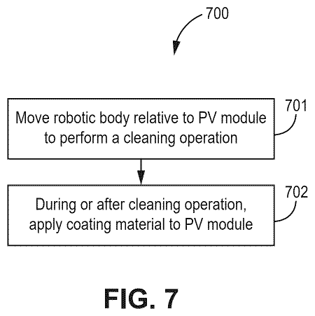

FIG. 7 is a flow diagram of an embodiment of a method 700 of applying a coating to a PV module using a robotic body. In some examples, the method 700 can be executed, at least in part, using any one of the features disclosed elsewhere herein. For instance, the method 700 could be executed by embodiments of the robotic cleaning system (e.g., robotic body and one or more fluidly connected reservoirs) disclosed elsewhere herein.

At step 701, the method 700 includes moving a robotic body relative to a PV module to perform a cleaning operation at the PV module using a cleaning applicator at the robotic body. As one example, the cleaning operation at the PV module can be performed by at least using a brush as the cleaning applicator. Using the brush as the cleaning applicator can cause particulate to be swept off of a surface of the PV module.

At step 702, the method 700 includes, during or after performing the cleaning operation at the PV module at step 701, applying a coating material to the PV module using a coating applicator at the robotic body. For example, at step 702, the coating material can be applied to at least a region of the PV module using the coating applicator at the robotic body after the cleaning applicator (e.g., brush) has passed over that same region of the PV module.

In a further embodiment of the method 700, the brush at the cleaning applicator can be a first brush, and this first brush can be disposed ahead of, relative to a direction of travel of the robotic body, the coating applicator. In such embodiment, the robotic body can further include a second brush that is disposed behind, relative to the direction of travel of the robotic body, each of the first brush and the coating applicator. Accordingly, for such embodiment, the method can further include a step that includes using the second brush to finish the coating material applied at the PV module by the coating applicator. For instance, the method 700 could include the step of using the second brush to finish the coating material (e.g., buff, polish, etc.) applied at the PV module by the coating applicator after the method 700 has used the robotic body to apply the coating material to the PV module.

In a further embodiment of the method 700, the method 700 can include an additional step of attaching the robotic body directly or indirectly to the PV module such that the robotic body contact the PV module. For example, one or more wheels at the robotic body can be placed to interface with the PV module, and the robotic body can move along the PV module via the attachment between the robotic body and the PV module(s).

Various non-limiting exemplary embodiments have been described. It will be appreciated that suitable alternatives are possible without departing from the scope of the examples described herein.

What is claimed is:

1. A robotic cleaning system comprising:
a robotic body comprising: a controller, a motive source coupled to the controller, a coating applicator coupled to the controller, and an attachment mechanism for attaching the robotic body to a photovoltaic module; and
a coating reservoir in fluid communication with the coating applicator to supply a coating material to the coating applicator,
wherein the robotic body is configured to apply the coating material, via the coating applicator, to the photovoltaic module.

2. The system of claim 1, wherein the coating material comprises a hydrophobic coating that is configured to reduce particulate accumulation at the photovoltaic module.

3. The system of claim 1, wherein the robotic body further comprises: a brush assembly coupled to the controller.

4. The system of claim 3, wherein the robotic body is configured to apply the coating material, via the coating applicator, to the photovoltaic module as the robotic body moves along the photovoltaic module via one or more wheels.

5. The system of claim 4, wherein the brush assembly is disposed at the robotic body ahead of the coating applicator relative to a direction of travel of the robotic body.

6. The system of claim 5, wherein the coating applicator is configured at the robotic body to apply the coating material to the photovoltaic module after the brush assembly has passed the photovoltaic module.

7. The system of claim 6, wherein the brush assembly is a first brush assembly, and wherein the robotic body further comprises a second brush assembly, the second brush assembly disposed at the robotic body behind the coating applicator relative to the direction of travel of the robotic body.

8. The system of claim 7, wherein the second brush assembly is configured to perform a finishing operation to the coating material applied at the photovoltaic module.

9. The system of claim 1, wherein the coating applicator comprises a plurality of nozzles spaced apart from one another about the robotic body.

10. The system of claim 9,
wherein the attachment mechanism comprises a first attachment mechanism at a first side of the robotic body configured to attach directly to a first end portion of the photovoltaic module and a second attachment mechanism at a second, opposite side of the robotic body configured to attach directly to a second, opposite end portion of the photovoltaic module, and
wherein the plurality of nozzles are disposed at the robotic body between the first attachment mechanism and the second attachment mechanism.

11. The system of claim 1, wherein the robotic body further comprises:
a valve in fluid communication with the coating applicator and the coating reservoir, the valve coupled to the controller,
a flow meter in fluid communication with the coating applicator,
wherein the valve is controllable by the controller to alter a fluid pressure and a fluid velocity of the coating material output from the coating applicator.

12. The system of claim 1, wherein the robotic body further comprises a cleaning solution applicator coupled to the controller.

13. The system of claim 12,
wherein the coating applicator comprises a first plurality of nozzles spaced apart from one another along a first location at the robotic body, and
wherein the cleaning applicator comprises a second plurality of nozzles spaced apart from one another along a second, different location at the robotic body.

14. The system of claim 13, wherein the first plurality of nozzles is configured at the robotic body to apply the coating material to the photovoltaic module after the brush assembly has passed the photovoltaic module and after the second plurality of nozzles has passed over the photovoltaic module.

15. The system of claim 14, further comprising:
a cleaning solution reservoir in fluid communication with the second plurality of nozzles to supply at least a fluid cleaning solution to the second plurality of nozzles.

16. A method of applying a coating to a photovoltaic module, the method comprising the steps of:
moving a robotic body relative to a photovoltaic module to perform a cleaning operation at the photovoltaic module using a cleaning applicator at the robotic body; and
during or after performing the cleaning operation at the photovoltaic module, applying a coating material to the photovoltaic module using a coating applicator at the robotic body.

17. The method of claim 16, wherein the coating material is applied to at least a region of the photovoltaic module using the coating applicator at the robotic body after the cleaning applicator has passed over the region of the photovoltaic module.

18. The method of claim 17, wherein the cleaning applicator comprises a brush.

19. The method of claim 18,
wherein the brush is a first brush, wherein the first brush is disposed ahead of, relative to a direction of travel of the robotic body, the coating applicator,
wherein the robotic body comprises a second brush that is disposed behind, relative to the direction of travel of the robotic body, the first brush and the coating applicator, and
wherein the method further comprises: after applying the coating material to photovoltaic module, using the second brush to finish the coating material at the photovoltaic module.

20. The method of claim 16, further comprising:
attaching the robotic body to the photovoltaic module such that one or more wheels at the robotic body contact the photovoltaic module.
